(19) United States
(12) Patent Application Publication
(10) Pub. No.: US 2005/0223024 A1
(43) Pub. Date: Oct. 6, 2005

(54) User-definable hierarchy for database management

(75) Inventors: William Hyun, Tiburon, CA (US); Martin Bigos, San Francisco, CA (US); Antony Chiang, San Francisco, CA (US); Lawrence Roberts, San Francisco, CA (US)

Correspondence Address: LAW OFFICE OF ALAN W. CANNON, 834 SOUTH WOLFE ROAD, SUNNYVALE, CA, 94086, US

(73) Assignees: Biotrue, Inc.; The Regents of the University of California

(21) Appl. No.: 11/096,011

(22) Filed: Mar. 30, 2005

Related U.S. Application Data
(60) Provisional application No. 60/558,346, filed on Mar. 31, 2004.

(51) Int. Cl. G06F 17/00

(52) U.S. Cl. 707/102

(57) ABSTRACT

Methods, systems and computer readable media for users of a shared database, file system, or other similar software system to browse files or records in the database according to any of the files' attributes in a standard hierarchical tree structure. Methods, systems and computer readable media that enable users to dynamically define and customize a hierarchy of files according to the quantity and priority of attributes that each user individually desires, such that the records or files are automatically rearranged and reorganized into the user-created hierarchy.

### CROSS-REFERENCE

This application claims the benefit of U.S. Provisional Application No. 60/558,346, filed Mar. 31, 2004, which application is incorporated herein by reference.

### GOVERNMENT RIGHTS

This invention was made with government support under federal grant no. R43 RR18043-01 awarded by the Department of Health and Human Services (National Institutes of Health). The United States Government may have certain rights in this invention.

### FIELD OF THE INVENTION

The present invention relates to the organization of information. More particularly the invention relates to the organization of files, such as files in a database.

### BACKGROUND OF THE INVENTION

Current computer file organization systems allow users to browse through a set of files, data, records or items in a standard hierarchy of organized, nested folders or tree structure. For example, current file managers with graphical user interfaces (e.g., Microsoft Windows®, MacOS®, Linux® and UNIX®) allow users to browse files only according to the hierarchy in which the files are stored and do not record the files' hierarchical location as an attribute of the files. That is, the files are stored in the form of a ‘tree’ with nested sub-branches, so that an end-user who wants to access a file must start at the beginning of a branch and browse through the appropriate branches in the appropriate order.

This hierarchical ‘tree’ arrangement is rigid and can be changed only by creating a new ‘tree’ or ‘branch’ and manually rearranging the files into the new structure. Thus, if a new hierarchy is desired, a user of a current file manager would have to create a new parallel structure, and then manually re-arrange the files one by one into the new set of folders according to the new set of categories or organization.

After new trees or branches are created, the end-user still must access a file by starting at the beginning of a branch and browsing through the branches, and any old trees or branches are discarded and cannot be reused.

Current file managers allow an end-user to create shortcuts such as aliases and links, but creating alternative hierarchies with such shortcuts is impractical on a large scale, as the end-user would have to systematically create the aliases and links and place them in the alternative hierarchies. Current file managers allow an end-user to ‘sort’ files at the end of a branch by attributes such as filetype or creation date, but do not allow the end-user to concurrently identify files with the same attributes on other branches.

U.S. Pat. No. 6,834,282 to Bonneau et al. describes a logical and constraint-based method that allows an administrator, such as a seller managing a business-to-business website, to more readily and flexibly set up an online catalog. The administrator defines a set of constraints for each node and must know in advance what the constraint should be (e.g., product=“PC”). The administrator must label each node with the appropriate label and must also determine the number of children nodes that the end user (e.g., buyer) will choose from. Thus, buyers are provided with a fixed hierarchy from which to browse and search. Although this solution provides an administrator with some flexibility in defining a hierarchy, and facilitates searching by users in that they can click on a node to perform an automatic search, it does not provide the user the flexibility to redefine the hierarchy or other organization of the data in a manner which is more intuitive or user-friendly to the individual user.

The need for organized and flexible hierarchal directory structure is especially great among users of complex data or numerous files. For example, biomedical data files may have numerous file attributes or ‘metadata’ attached to them, such as file name, date of creation, type of instrument creating the file, file type, date of modification, patient identity, tumor type, project, researcher, etc. A biomedical researcher may generate hundreds or thousands of such files.

In order to keep such files organized, a researcher will typically create a multi-level hierarchy of organization, whether using an operating system's file manager or a database system. The researcher may first create a top level set of folders organized by project, for example. Within each project folder, there may be a second level of organization by lab staff. Within each lab staff folder, there may be a third level of organization by date. Within each date folder there may be located files/data records/nodes/leaves of the tree hierarchical structure.

Users of the data or files find files in this hierarchy by drilling down into the appropriate folder or branch, in order to store, retrieve, or modify files. This process is commonly referred to as “browsing.” However, existing methods do not allow for the user to redefine the hierarchy and automatically reorganize the items into a new browsing structure, and thus each user is forced to access files according to the organizational structure created by the researcher that originally created the organizational structure. However, it is likely that different users will have different needs and/or preferences as to the way in which the user would like to have the files organized. Existing methods do not provide the flexibility for various users to readily re-order an organizational hierarchy of files, but allow only for either labor intensive manual rearrangement of the items, or a query on certain metadata of the items that displays matching files in a single flat list without the original or any other hierarchy. Many database software applications offer search or query forms where the end user can select files meeting certain file attribute criteria. However, the user must enter the necessary search criteria and receive a set of resulting matches in a single flat listing without hierarchy or priority.

There is a need for providing flexible organizational hierarchical structures that may be readily and intuitively reorganized according to different users' differing needs and/or preferences.

### SUMMARY OF THE INVENTION

The present invention provides methods, systems and computer readable media for dynamically defining a hierarchical organization of files to define pathways for access to the files stored in a storage system, wherein the storage system also contains metadata attributes associated with the files, and wherein the files and metadata can be searched upon. A user interface is provided for user selection of attributes to be assigned to levels of the hierarchical organization. Through the user interface, a user may select a first attribute by which the files will be organized in a first level of the hierarchical organization, and select a second attribute by which the files will be organized in a second level of the hierarchical organization. Selections may be continued in this manner for a predetermined number of attributes different from the first and second attributes, via the user interface, by which the files will be organized in an additional predetermined number of levels of the hierarchical organization.

The predetermined number of selections may be selected and predetermined by the user, and may be varied to change the level of granularity provided by the hierarchical organization.

Systems, methods and computer readable media are provided for saving the user selections as a template, wherein the defined hierarchical organization can be re-used after saving without the need to re-enter the selections.

Systems, methods and computer readable media are provided for browsing the files using such a user-defined hierarchical organization. Browsing may include: displaying a first set of at least one member characterized by the first attribute; selecting a member from the first set; and displaying a second set of at least one member characterized by the second file attribute which are also characterized by the selected member of the set of first file attributes.

Continuing with the browse, the browse may further include selecting a member from the second set; and displaying a third set of at least one member characterized by a third file attribute which are also characterized by the first and second file attributes of the selected member from the second set.

This process may be carried out further, continuing the selecting and displaying steps to select and display additional levels up to the predetermined number of levels of the hierarchical organization. Thus, the selecting and displaying steps may be continued until a last level of hierarchical organization is displayed, thereby displaying files characterized by all the attributes associated with the selected members.

A system is provided for browsing a storage system containing files, wherein the storage system also contains metadata attributes associated with the files, wherein the files and metadata can be searched upon. The system includes: means for displaying members of the hierarchical organization; means for interactively selecting a member from members of a displayed level of the hierarchical organization, and means for displaying members of a next lower level of the hierarchical organization, in response to the selection of the member, the displayed members of the next lower level of the hierarchical organization being characterized by all attributes of all previously selected members at higher levels of organization.

A system is provided for dynamically defining a hierarchical organization of files to define pathways for access to the files stored in a storage system, wherein the storage system also contain metadata attributes associated with the files, and wherein the files and metadata can be searched upon. The system includes: a user interface for user selection of attributes to be assigned to levels of the hierarchical organization; means for selecting a first attribute, via the user interface, by which the files will be organized in a first level of the hierarchical organization; means for selecting a second attribute, via the user interface, by which the files will be organized in a second level of the hierarchical organization; and means for continuing selections of a predetermined number of attributes different from the first and second attributes, via the user interface, by which the files will be organized in an additional predetermined number of levels of the hierarchical organization.

The predetermined number of attributes may be user selectable and may be varied to change the level of granularity provided by the hierarchical organization.

Means for saving the selections as a template are provided, wherein the defined hierarchical organization can be re-used after saving without the need to re-enter the selections.

Means for browsing the files via the defined hierarchical organization are provided.

Means for browsing may include means for displaying a first set of at least one member characterized by the first attribute; means for selecting a member from the first set; and means for displaying a second set of at least one member characterized by the second file attribute which are also characterized by the selected member of the set of first file attributes.

Means for browsing may further include means for selecting a member from the second set; and means for displaying a third set of at least one member characterized by a third file attribute which are also characterized by the first and second file attributes of the selected member from the second set.

Still further, the means for browsing may include means for continuing the selecting and displaying processes to select and display additional levels up to the predetermined number of levels of the hierarchical organization.

The invention allows users of a shared database, file system, or other similar software system to browse files or records in the database according to any of the files' attributes (such as name, date of creation, file type, date of modification, or other keywords) in a standard hierarchical tree structure.

The present invention enables users to dynamically define and customize a hierarchy of files according to the quantity and priority of attributes that each user individually desires, such that the records or files are automatically rearranged and reorganized into the user-created hierarchy.

These and other advantages and features of the invention will become apparent to those persons skilled in the art upon reading the details of the invention as more fully described below.

### BRIEF DESCRIPTION OF THE DRAWINGS

FIG. 1 shows a schematic of an exemplary network that the present invention may be employed in.

FIG. 2 shows a portion of an interface that may be displayed to a user of the system on the user's display when accessing the system according to the present invention.

FIG. 3 shows an example of a hierarchical organization of files that may be created and/or browsed according to the present invention.

FIG. 4 shows another example of a hierarchical organization of files that may be created and/or browsed according to the present invention.

### DETAILED DESCRIPTION OF THE INVENTION

### Definitions

The term “file” as used herein, refers to any data structure that can be stored in a hard-drive or other storage device. As used, the term “file” refers not only to a single data file, in accordance with its general use, but also includes groups of files, such as folders, directories, etc. References to “files” may also be references to data records, database records or other items requiring systematic organization.

The present invention facilitates users' browsing a set of files organized in a multiple level hierarchy according to key metadata attributes. Further, users of the present system may dynamically redefine and customize the hierarchy of the files according to a new set of attributes, a new order of attributes and/or a new number of such attributes. The system automatically rearranges files into a new browsing hierarchy that is intuitive to the user, because the user interactively selects the order of the hierarchy.

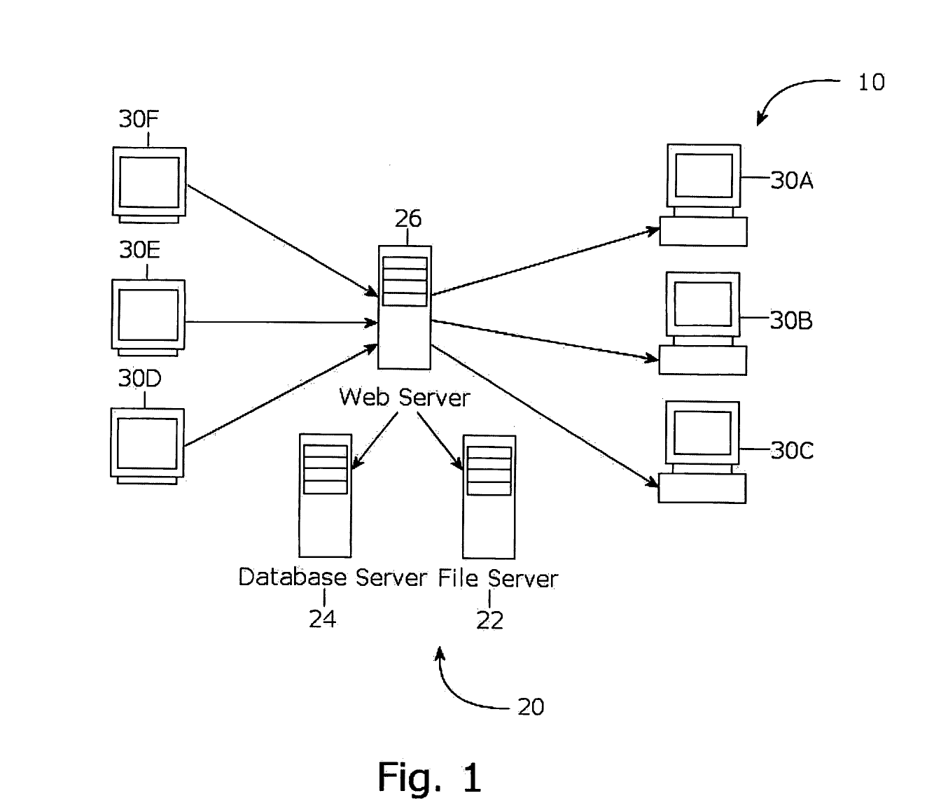

FIG. 1 shows a schematic of an exemplary network that the present invention may be employed in. It is noted here that the present invention is not limited to use with networks of the type illustrated in FIG. 1, but is useful for any network where the users of the network desire to save files to a central storage location for access by users of the network. Still further, the present invention may be employed on a single computer, providing the advantages thereof to a single user or to multiple users of the same computer Thus, the present invention is applicable to any computer to save files to a local storage device, in a manner where they may be browsed in a multiple level hierarchy according to key metadata attributes and/or dynamically redefined and customized into a hierarchy of files according to a new set of attributes, a new order of attributes and/or a new number of such attributes.

Network 10 includes a centralized storage system 20 that is used to centrally store, in an organized and searchable database, files and metadata associated with the files, that may be created and uploaded from any of computers 30A, 30B, 30C, 30D, 30E and 30F. In this example, central storage system 20 includes files server 22 for central storage of files, database server 24 for managing and cataloging the files on file server 22 and web server 26 which interfaces between the client computers and the file and database servers. It is noted however, that different configurations may be provided for central storage system 20, depending upon the need of the particular network. For example, file storage and database management software may be stored on a single server, which may be a web server or not, if the network is established as an intranet, for example.

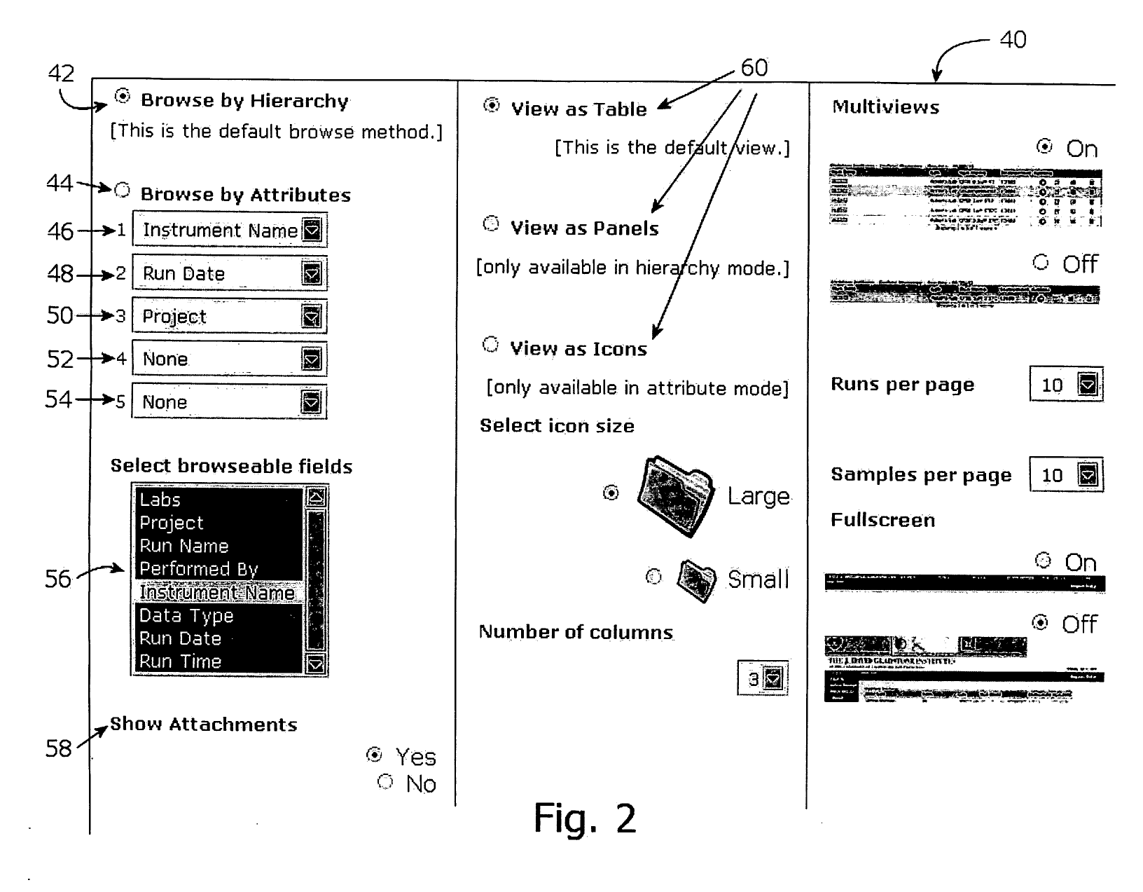

FIG. 2 shows a portion of an interface 40 that may be displayed to a user of the system on the user's display when accessing the system. Interface 40 provides for user input for browsing a hierarchy of files in a central 20 or local storage system as the case may be. The files that the user wishes to access will generally be initially organized according to a hierarchy (i.e., the default hierarchy), determined by the database manager or whoever initially sets up the organizational scheme for the storage of files in this particular storage system. The user is provided an option to browse by this default hierarchy by clicking on the “Browse by Hierarchy” button 42. The “Browse by Hierarchy” mode may also be set up as the default mode so that the user can automatically begin browsing the default hierarchy without changing any settings.

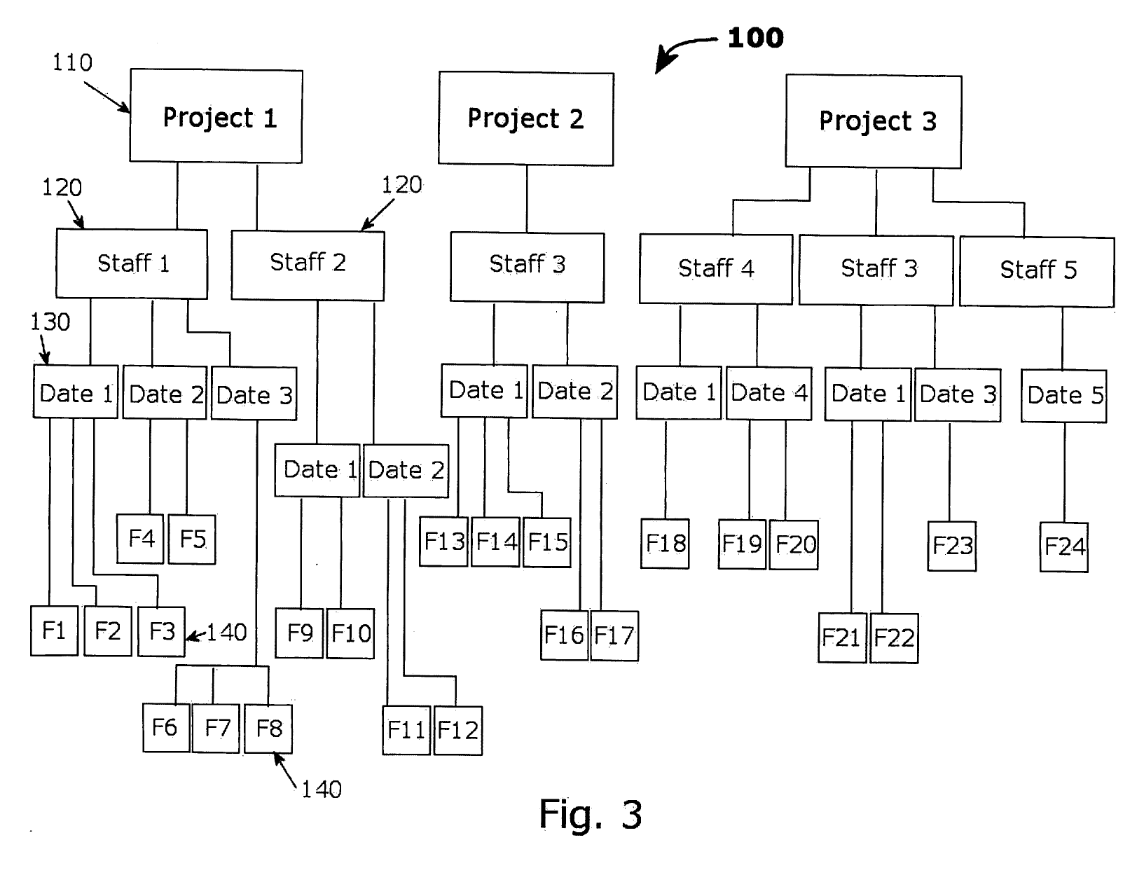

FIG. 3 shows a non-limiting example of a default or initial hierarchy 100 that may be employed. Of course, other hierarchical organizations may be chosen by the person or team creating the initial, default hierarchy. In this example, the top level of folders chosen for the default hierarchy are organized according to “project” Thus, project folders 110 (in this example, three project folders resulted (i.e., “Project 1”, “Project 2” and “Project 3”)) are shown as the top level set of folder. The second level of organization in hierarchy is by lab staff. Thus, staff folders 120 (in this example, six staff folders are shown) are shown as the second level of organization. Note however, that “Staff3” appears under both “Project 2” as well as “Project 3”, as lab staff member 3 has participated in both Project 2 and Project 3 and has created and stored files relative to both projects.

A third level of organization within each staff folder 120 is provided as date folders 130. Thus, each of the files stored by each of the staff members within a particular project are sorted according to date of creation of the files in folders 130. Upon accessing a date folder, files 140 that correspond to the particular project, staff member and date are accessed.

Thus, by using the default “Browse by Hierarchy” mode, a user in this example may access files by first selecting on the project 110 of interest, then selecting on the staff folder 120 for the staff member whose files the user is interested in accessing, then selecting a particular date 130 of files to review, upon which the files for that date will be displayed, from which the user can select to open any and all of the displayed files.

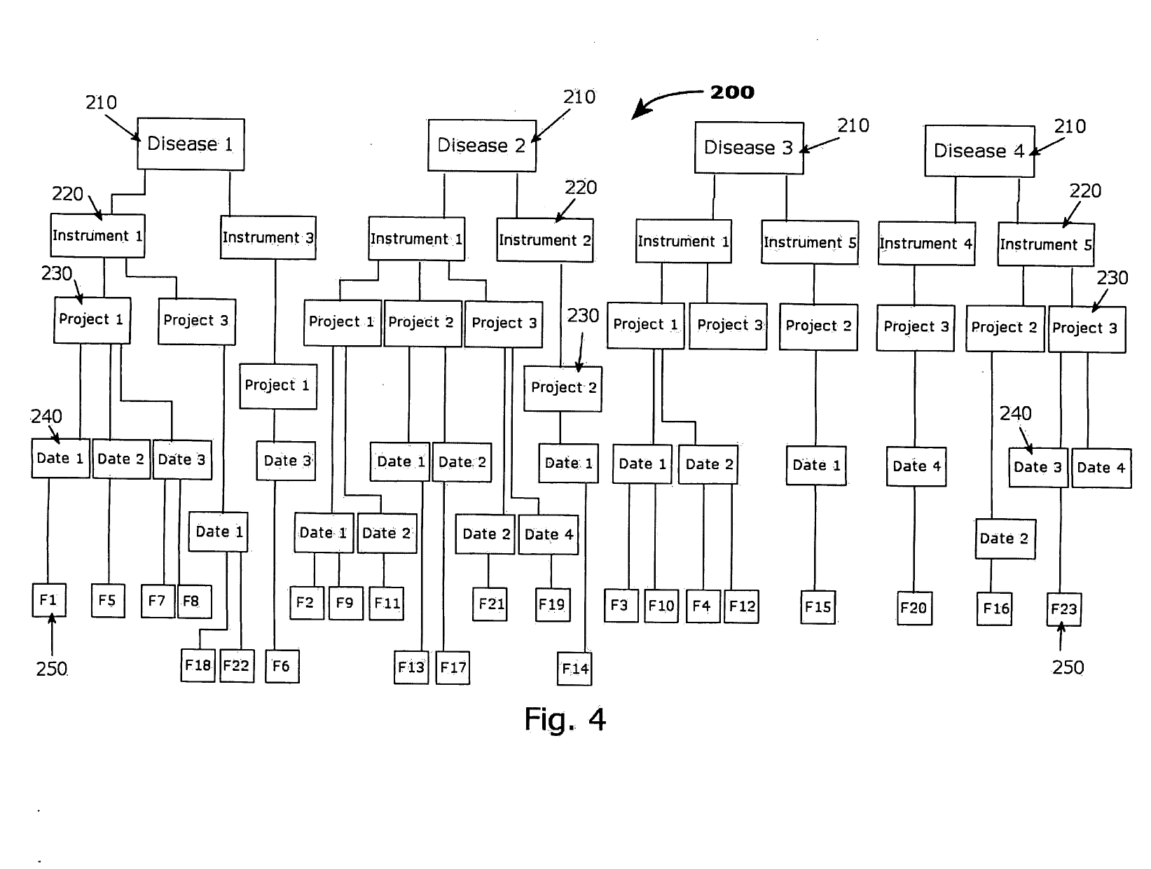

However, as alluded to above, this user or another user may find it more intuitive or useful to see the same files organized according to a different hierarchy. In such a circumstance, the system facilitates the creation of a custom hierarchy. For example, the user may create a custom hierarchy to organize not by project, but by disease type (e.g., breast cancer, liver cancer, etc.) or by any other metadata attribute that is stored with the files. FIG. 4 shows an example of a customized hierarchy 200 created by a user for purposes of visualizing this description of the example. Within each disease folder, the second level of organization in this example was chosen as “instrument type”. Thus, instrument type folders 220 are shown for files or data created by each particular instrument type (e.g., image, microarray, flow, etc.) used for each of the disease categories. Within the instrument-type folder, the user in this example has chosen to organize files by project, as shown by project folders 230. Further, with project folders 230, the files have been organized by date, as shown by date folders 240. Finally, by accessing a date folder 240, the data files 250 corresponding to the attributes of the selected pathway in the hierarchy 200 are displayed.

Note that the hierarchy 200 constructed in FIG. 4 has been organized to a higher level of granularity than that of the example in FIG. 2, as the user has chosen to organize according to five levels of hierarchy, as opposed to the four levels used in hierarchy 100. Thus, the system also provides flexibility to the user as to the degree of granularity with which to display the files in the hierarchy. It can be noted that, in general, the number of files contained in each date folder 240 is, on average, less than the number of files contained in each date folder 130.

Referring back to FIG. 2, the system, through interface 40 provides for user input in order to browse files by metadata attributes, as well as create a customized hierarchy as described above with reference to FIG. 4. By selecting the “Browse by Attributes” 44 button or function, the user is allowed to specify, through menu bars 46,48,50,52,54 the attributes to be used to organize the files according to a hierarchy. Note that although only five menu bars are shown in FIG. 2, that the present invention is not limited to five menu bars, as more or fewer may be implemented in interface 40 depending upon the level of granularity that needs to be accessible to a user. In the example shown, the user has selected only three levels of hierarchical organization (four, counting the files level), as indicated by “none” in menu bars 52 and 54. In this example, the top level of folders is “Instrument Name” 46, the next level is “Run Date” 48 and the bottom level is “Project” 50, which may be accessed to access files (which may be considered to be a fourth level of organization). Thus, by selecting the “Browse by Attributes” mode and making the desired selections among menu bars 46,48,50,52,54, the system permits the user to redefine the hierarchy and have the files or data automatically rearranged into the new structure without having to manually reorganize them or conduct a query each time.

The system stores the preferences selected in the menu bars 46,48,50,52,54 as a template on the storage system so that the user does not have to re-input the selections each time that the user wants to access files according to this selected organization scheme. Thus, the user may return to the system, log in, and select this particular hierarchy by which to search files. Each user may create more than one customized hierarchical organization and save each one under a different title or name, so that reuse of any customized hierarchy is easy and intuitive upon log in.

By making selections in the menu bars 46,48,50,52,54, the user is effectively inputting query terms to the system upon which the system files are searched. However, the user himself or herself never has to generate a query, since the system does this automatically upon the user's choices selected in menu bars 46,48,50,52,54. Thus, the process is very intuitive to the user and only has to be done once per customized hierarchy, since each customized hierarchy may be saved as a template.

The “Select Browseable Fields” input box 56 allows the user to select the fields of metadata associated with the files by which the results will be identified and displayed. Interface 40 provides the user with further options, such as whether or not to show attachments 58 on the display of results, type of view (e.g., table, pane or icons) and various other attributes of the display of results, such as icon size, number of columns to be displayed, multiview, runs per page and full screen view.

As noted, each user can create and save multiple, various hierarchical views of the files. As such, the present invention allows one set of files to be organized in multiple ways. In a scientific research environment, such a user-definable file hierarchy can be expected to speed throughput, data processing, analysis and interpretation of results. In other work environments, the invention can result in similar workflow improvements.

A user may also create and define new file attributes, so that he or she could have practically limitless varieties of hierarchies. These attributes must, of course be metadata attributes which are searchable by the system. Browsing, as well as custom organization of files, is made possible by storing metadata for each file in a database (i.e., storage system). As noted earlier, a user browsing files is in practice making a database query that returns files having the queried attribute. As the user progresses down a browsing trail, subsequent queries are limited according to the user's prior choices. Each query in the browsing trail is marked and recorded, so that the end-user can both reverse his or her steps, as well as view the files later using the same hierarchy.

In the biomedical research example described above, each file has at least the following attributes: “project,” “staff,” “date,” “instrument,” “disease,” and “size. A user's browse using hierarchy 100 to browse the files may be implemented by first querying the first level attribute of all files, in this case “project”, and then displaying the distinct data items for the projects attribute, i.e., project folders 110, organized by the particular variable. Thus, if among one thousand files contained in the database stored by the storage system, there are three projects identified, then the first level of organization displays three “folders” 110 each titled with a project name, as shown in FIG. 3.

Implementing the Browse Mode

While in the “Browse by Hierarchy” default mode 42, when the user clicks on Project 1 110 to drill down one level, the second level of hierarchal folders is displayed. In this example, the browsing is implemented by querying files relevant to Project 1 110 and identifying the distinct data items for the “Staff” attribute. Thus if among the files for Project 1 110, there are two staff members identified, then the second level of organization displays two folders 120 each titled with the name of the respective staff, e.g., “Staff1” and “Staff2”.

When the user clicks on Staff1 120 to drill down one more level, the third level of hierarchal folders is displayed. For this example, the browsing is implemented by querying files relevant to “Project 1 and Staff1” and identifying the distinct data items for the “Date” attribute. Thus if among the files for Project1/Staff1, there are three experiment dates identified, then the third level of organization is displayed as three folders 130 each titled with the name of the respective date, e.g., “Date1”, “Date 2” and “Date3”.

If the user clicks on Date1 130, as the last level of hierarchal organization, the files 140 (e.g., files “F1”, “F2” and “F3”) in folder “Date 1” 130 are displayed. The equivalent database query would have been to find the files matching “Project1 AND Staff1 AND Date1” and display the result. Rather than typing out such a query, the user has intuitively drilled through an organized set of folders or hierarchy 100. By providing the user a “bread crumb” trail of their drilled down path into the hierarchy, the system provides the user with orientation and position within the tree structure and easier navigation around the tree structure.

Implementing the Dynamic User-Definable Hierarchy

A user may utilizes interface 40 to redefine the hierarchy. The default hierarchy displayed in the “Browse by Hierarchy” mode 42, for example, may be displayed as described above with regard to hierarchy 100, i.e.,:
Level 1: Project
Level 2: Staff
Level 3: Date
Level 4: [none]
Level 5: [none] and so on for additional possible levels.

In order to create a customized hierarchy, the user selects the “Browse by Attributes” mode 44, and can then select from menu bars 46,48,50,52,54 or pull down choice lists or other interface tools to change the hierarchy to be displayed as hierarchy 200, i.e.:
Level 1: Disease
Level 2: Instrument
Level 3: Project
Level 4: Date
Level 5: [none] and so on for additional possible levels.

The user may then save this configuration or set of preferences, of which many configurations could be saved as templates, and return to the browse mode 42. Upon returning to the “Browse by Hierarchy” mode 42, the same data files will now have been effectively re-organized into a new set of folders defined by hierarchy 200, and as shown in FIG. 4.

The user may use hierarchy 200 to select a folder from the first level of folders 210, named by each Disease type rather than by Project Name, to drill down to the second level and see a set of folders 220 within the selected Disease type which are named for the instruments used to create the files therein. For example, if the user were to select “Disease 4” 210, then folders 220 named “Instrument 4” and Instrument 5” would be displayed. Drilling to the third level, the set of folders 230 are named for the set of projects created by use of the selected instruments with regard to Disease 4. For example, if the user selects the “Instrument 5” folder 220, then the “Project 2” and “Project 3” folders 230 are displayed. However, if the user were to select the “Instrument 4” folder 220, then only the “Project 3” folder would be displayed. Thus where use of hierarchy 100 begins with displaying all three project folder 110 in this example, these folders may not all be relevant to the user's current task, and by reorganizing the hierarchy to hierarchy 200, the user effectively filters out at least Project 1, and also Project 2 if the user is only interested in files relating to Instrument 4.

The Table below lists a pseudocode describing process steps that are carried out by the system in implementing a browse session according to the present invention. The process is described beginning at a time after the user has chosen a specific hierarchy through selected preferences as described above.

```
TABLE
1000 (user logs in, prefs stored in session)
1010 browse display function is called with container id. (is null to
begin)
1020 look up the current user's permissions
1030 sort the hierarchy prefs into associative array
1040 get current step (is null to begin)
1050 create history of previous steps
1060 create query based on previous steps (and the path chosen,
given by the selected container id) and next step (group by the field)
=> i.e. SELECT * FROM runs WHERE
    previous_step_field1 =previous_path chosen1 AND
    previous_step_field2=previous_path chosen2
    GROUP BY next_step_field
1070 execute query taking permissions into account
1080 format results according to prefs and permissions
1090 provide step and container id info in the link for each item
1100 output page
1110 user clicks link (w. container id and step), process cycles
```

At step 1000, the user logs into the database on the storage system. At step 1010, the system calls a function to show to the user a browse display, with a container of items (e.g., data files) with the characteristic “container id”, which is initially null. The system looks up the user's permissions at step 1020 and sorts the user's hierarchy preferences into an associative array at step 1030.

At step 1040, the system sets a step value to the level of the hierarchy to which the user has browsed. At the top level of the hierarchy, the step value is initially null. A history of all previous steps is created or added to at step 1050.

At step 1060, a database query is created based on the previous steps and the next level in the hierarchy after the current step. The query calls for the selection of all items having the characteristic of the container id's selected by the user in the previous steps, and for the selected items to be grouped according to the container id fields available in the next level in the hierarchy.

At step 1070, the query is executed while taking into account the permissions determined at step 1020, so that the query does not return items to which the user does not have authority to access.

At step 1080, the results of the query are formatted for display as links according to any user preferences that may have been set and while taking permissions (such as read-only, edit and/or delete) into account. Step 1090 provides that each link either (1) contains step and container id information that allows the process to cycle from that point, or (2) identifies an item for retrieval. The results are displayed to the user at step 1100.

Step 1110 permits the user to select a link. The link either (1) cycles the process from step 1000, based on the information recorded at step 1090, to allow the user to browse to the next level in the hierarchy or (2) returns the item being sought by the user.

The present invention is particularly useful in collaborative environments where different users desire to browse a database in hierarchies specific to each user. Even if a set of files or records are organized into a hierarchy that one user finds optimal, it is likely with a variety of users of the same data/file set that other users would find a different hierarchy more valuable. Advantages provide by the present system are especially useful for organization of any type of data with more than two attributes to browse by. The browsing techniques described herein provide a significantly more intuitive method of narrowing the set of choices through single clicking.

The invention can be applied to a diverse variety of types of information, data, fields, industries, etc. A software developer may use the invention to offer flexible browsing features for file or database management systems for end-users in any data- or file-intensive environment, including but not limited to scientific research in all fields, clinical research, law firms, public information databases, product catalogs, customer/sales databases, dating services/listings, library catalogs or archives, music catalogs/listings such as jukebox, art databases, inventory systems, housing databases, restaurant listings, TV or movie listings, etc.

For example, the invention may be applied to restaurant listings in a database, where a user would have the option of organizing the data in an intuitive manner to provide the most efficient search results. During one search, a user may want to first browse by neighborhood, then at the second level browse by price range, then at the third level by cuisine. The motivation for setting up such a hierarchy may be that the user wants to eat very close to his/her present location at a casual restaurant, and would be willing to consider two or three different types of possible cuisines among the dozens available. On another occasion, the user may be more interested in quality dining and therefore may set the top level of the hierarchy as “food star rating”, followed by levels specifying the ‘date of establishment of the restaurant” and then by “service rating”. A motivation for this hierarchy may be that the user is looking for a high class, recently established, trendy restaurant with a high quality rating. The point is that the system provides for an intuitive, efficient method of providing a highly individualized hierarchy for browsing.

In regard to medical technology, as another example, a database that stores files for a medical device product manufacturer may organize the files by project, then by phase of development. However, in designing a new product, a designer might wish to find files that other designers have created that could help with a specific problem. In customizing the new hierarchy, the designer may rearrange the organization of the files such that the top level of organization is by material (e.g. “plastic,” “aluminum,” “steel,” “foam”) and then clicking on the plastic folder, the next level of folders is type of file (e.g. “Photoshop,” “Illustrator,” “Word,” “Excel”) and then selecting illustrator, the files are organized by project (e.g. “catheter,” “surgical device,” “disposable needle,” etc.). The designer can then browse first for the specific matches to the current problem, seeing how others designed around a certain issue with a plastic piece shaped in a certain way performing a certain function. However, if no useful files are found, intuitive browsing can lead the designer to view either plastic parts in unrelated products, or steel parts in related products.

In the library archive community, whether documents or publications, there is often great discussion and disagreement between institutions and even within a single institution as to how such items should be organized. With the current invention, each item may be given set attributes that are non-controversial such as author, date, multiple subject keywords, etc. Each archivist, librarian, researcher, consumer, can then organize according to their priorities and needs through use of the present system as described above.

Still further, the user definable hierarchy may be employed in other applications, both computer based and physical. In a manufacturing or retail environment, a physical system for providing parts or products, with each part in a container, the user may establish various hierarchies, using the present system by which to present the available parts to the user. For example, at the hardware store, the current system provides for a flat display of multiple color samples of paint organized typically by manufacturer, then by color family. Instead an application of the invention could allow the user to define first level to find type of paint (latex, interior, gloss, etc.), then the next level of selection may be by color family, with the samples then organized by price. The user would then be presented with the appropriate display of color samples.

Similarly, in a jukebox system, one user might choose first by decade, then by slow/fast, then select a song to be played. Alternatively, another user may choose first by genre (jazz, rock, pop, etc.), then by artist, then by album, then select a song to be played.

An example of a non-database computer based application is use of the system for organization of a virtual museum experience. One gallery visitor may ask for the galleries to be classified according to the traditional organization of region, then by century, then by style. Another gallery visitor might prefer to browse first by subject (see all the figurative art together, landscape, still life, historical), then by medium (see all the oil paintings, then the drawings, then the sculptures, etc.), then by artist.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, hardware, software, process, process step or steps, to the objective, spirit and scope of the present invention. All such modifications are intended to be within the scope of the claims that define the present invention.

1. A method of dynamically defining a hierarchical organization of files to define pathways for access to the files stored in a storage system, wherein the storage system also contain metadata attributes associated with the files, and wherein the files and metadata can be searched upon, said method comprising the steps of:
providing a user interface for user selection of attributes to be assigned to levels of the hierarchical organization;
selecting a first attribute, via the user interface, by which the files will be organized in a first level of the hierarchical organization;
selecting a second attribute, via the user interface, by which the files will be organized in a second level of the hierarchical organization; and
continuing selections of a predetermined number of attributes different from said first and second attributes, via the user interface, by which the files will be organized in an additional predetermined number of levels of the hierarchical organization.

2. The method of claim 1, wherein the predetermined number is user selectable and may be varied to change the level of granularity provided by the hierarchical organization.

3. The method of claim 1, further comprising saving the selections as a template, wherein the defined hierarchical organization can be re-used after saving without the need to re-enter the selections.

4. The method of claim 1, further comprising browsing the files via the defined hierarchical organization.

5. The method of claim 4, wherein said browsing comprises the steps of:
displaying a first set of at least one members characterized by the first attribute;
selecting a member from said first set; and
displaying a second set of at least one members characterized by the second file attribute which are also characterized by the selected member of the set of first file attributes.

6. The method of claim 5, wherein said browsing further comprises the steps of:
selecting a member from said second set; and
displaying a third set of at least one members characterized by a third file attribute which are also characterized by the first and second file attributes of the selected member from the second set.

7. The method of claim 6, comprising continuing said selecting and displaying steps to select and display additional levels up to the predetermined number of levels of the hierarchical organization.

8. The method of claim 7, wherein said selecting and displaying steps are continued until a last level of hierarchical organization is displayed, thereby displaying files characterized by all the attributes associated with the selected members.

9. A method of browsing a storage system containing files, wherein the storage system also contains metadata attributes associated with the files, wherein the files and metadata can be searched upon, said method comprising the steps of:
displaying a first set of at least one members characterized by a first file attribute and defining a first level of hierarchical organization of the files;
selecting a member from said first set; and
displaying a second set of at least one members characterized by a second file attribute which are also characterized by the first file attribute of the selected member.

10. The method of claim 9, further comprising the steps of:
selecting a member from said second set; and
displaying a third set of at least one members characterized by a third file attribute which are also characterized by the first and second file attributes of the selected member from the second set.

11. The method of claim 10, comprising continuing said selecting and displaying steps to select and display additional levels of the hierarchical organization.

12. The method of claim 11, wherein said selecting and displaying steps are continued until a last level of hierarchical organization is displayed, thereby displaying files characterized by all the attributes associated with the selected members.

13. The method of claim 9, further comprising selecting attributes to be assigned to various levels of the hierarchical organization, and assigning the selected attributes to levels of the organization that they were selected for.

14. A system for browsing a storage system containing files, wherein the storage system also contains metadata attributes associated with the files, wherein the files and metadata can be searched upon, said system comprising:
means for displaying members of the hierarchical organization;
means for interactively selecting a member from members of a displayed level of the hierarchical organization, and
means for displaying members of a next lower level of the hierarchical organization, in response to the selection of the member, said displayed members of the next lower level of the hierarchical organization being characterized by all attributes of all previously selected members at higher levels of organization.

15. A system for dynamically defining a hierarchical organization of files to define pathways for access to the files stored in a storage system, wherein the storage system also contain metadata attributes associated with the files, and wherein the files and metadata can be searched upon, said system comprising:
a user interface for user selection of attributes to be assigned to levels of the hierarchical organization;
means for selecting a first attribute, via the user interface, by which the files will be organized in a first level of the hierarchical organization;
means for selecting a second attribute, via the user interface, by which the files will be organized in a second level of the hierarchical organization; and
means for continuing selections of a predetermined number of attributes different from said first and second attributes, via the user interface, by which the files will be organized in an additional predetermined number of levels of the hierarchical organization.

16. The system of claim 15, wherein the predetermined number is user selectable and may be varied to change the level of granularity provided by the hierarchical organization.

17. The system of claim 15, further comprising means for saving the selections as a template, wherein the defined hierarchical organization can be re-used after saving without the need to re-enter the selections.

18. The system of claim 15, further comprising means for browsing the files via the defined hierarchical organization.

19. The system of claim 18, wherein said means for browsing comprises means for displaying a first set of at least one members characterized by the first attribute; means for selecting a member from said first set; and means for displaying a second set of at least one members characterized by the second file attribute which are also characterized by the selected member of the set of first file attributes.

20. The system of claim 19, wherein said means for browsing further comprises means for selecting a member from said second set; and means for displaying a third set of at least one members characterized by a third file attribute which are also characterized by the first and second file attributes of the selected member from the second set.

21. The system of claim 20, comprising means for continuing said selecting and displaying to select and display additional levels up to the predetermined number of levels of the hierarchical organization.

22. A computer readable medium carrying one or more sequences of instructions for browsing a storage system containing files, wherein the storage system also contains metadata attributes associated with the files, wherein the files and metadata can be searched upon, wherein execution of one or more sequences of instructions by one or more processors causes the one or more processors to perform the steps of:
displaying a first set of at least one members characterized by a first file attribute and defining a first level of hierarchical organization of the files;
selecting a member from said first set; and
displaying a second set of at least one members characterized by a second file attribute which are also characterized by the first file attribute of the selected member.

23. A computer readable medium carrying one or more sequences of instructions for dynamically defining a hierarchical organization of files to define pathways for access to the files stored in a storage system, wherein the storage system also contain metadata attributes associated with the files, and wherein the files and metadata can be searched upon, wherein execution of one or more sequences of instructions by one or more processors causes the one or more processors to perform the steps of:
selecting a first attribute, via a user interface, by which the files will be organized in a first level of the hierarchical organization;
selecting a second attribute, via the user interface, by which the files will be organized in a second level of the hierarchical organization; and
continuing selections of a predetermined number of attributes different from said first and second attributes, via the user interface, by which the files will be organized in an additional predetermined number of levels of the hierarchical organization.
